(19) United States
(12) Patent Application Publication
(10) Pub. No.: US 2009/0112835 A1
(43) Pub. Date: Apr. 30, 2009

(54) Natural language database querying

(76) Inventor: Marvin Elder, Carrollton, TX (US)

Correspondence Address: STEVEN THRASHER, 391 SANDHILL DRIVE, RICHARDSON, TX, 75080, US

(21) Appl. No.: 12/004,255

(22) Filed: Dec. 20, 2007

Related U.S. Application Data
(63) Continuation-in-part of application No. 11/923,164, filed on Oct. 24, 2007.

(51) Int. Cl. G06F 17/30

(52) U.S. Cl. 707/4; 707/E17.124

(57) ABSTRACT

The invention is natural language database querying (NLDQ), by a) allowing a user to type an information request using phrases stated in a natural language such as English, b) matching the phrases in the request to semantic objects stored in a hierarchy of ontologies, c) automatically converting the matched semantic phrases into the names of synchronized conceptual objects stored in the same taxonomy, d) automatically mapping the conceptual objects to metadata objects in one or more target databases; e) from the mapped metadata objects, generating a database query stated in a database language such as Structured Query Language (SQL), and f) executing the database query against the target database(s).

### CROSS-REFERENCE TO RELATED APPLICATION

The invention is related to and claims priority from pending U.S. Provisional patent application Ser. No. 11/923,164 to Elder, et al., entitled NATURAL LANGUAGE DATABASE QUERYING filed on 20 Aug. 2004 which is incorporated by reference herein in its entirety.

### TECHNICAL FIELD OF THE INVENTION

The present invention relates generally structured data querying, and more particularly to natural language database querying.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Millions of relational databases and other types of structured data sources house information that non-technical “end users” would like to access directly—if they had the means to do so. Unfortunately, with today's information technology only data-savvy technical specialists can accurately extract information from most of these structured data sources, using data management tools and Business Intelligence (BI) products. Consequently, non-technical end users must rely on information technology specialists to generate reports and queries for them, in order to retrieve information from structured data sources.

Accordingly, there is a need for systems, methods and devices that enable a person with no data access training to effectively search and retrieve information from structured data sources, requesting such information in his or her common everyday vernacular in a natural language.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 shows the Natural Language Interface methods by which an end user composes a Natural Language (NL) request.

FIG. 2 shows the first server-side component module receiving the end user's NL request.

FIG. 3 shows a Clarification Dialog between the system and the user on his or her browser.

FIG. 4 shows a server-side process that maps the pattern-matched semantic phrases to synchronized ontology concept objects and constructs any restriction conditions implied in the NL request.

FIG. 5 shows the server-side process that utilizes inferencing to reify the matched ontology concept objects up to the top-level concept objects in the taxonomy.

FIG. 6 shows a server-side process which maps the top-level ontology's concept objects to target database metadata objects.

FIG. 7 shows a process by which navigation path algorithms optimally join metadata objects to construct the JOIN clause of the database query statement.

FIG. 8 shows an embodiment of the invention that semi-automatically extends semantic phrases and any mirrored concept objects.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Computing platforms are computers, such as personal computers, workstations, servers, or sub-systems of any of the aforementioned devices. Further, a computing platform may be segmented by functionality into a first computing platform, second computing platform, etc. such that the physical hardware for the first and second computing platforms is identical (or shared), where the distinction between the devices (or systems and/or sub-systems, depending on context) is defined by the separate functionality which is typically implemented through different code (software).

Of course, the foregoing discussions and definitions are provided for clarification purposes and are not limiting. Words and phrases are to be given their ordinary plain meaning unless indicated otherwise.

### Description of the Drawings

### Natural Language Interface (NLI)

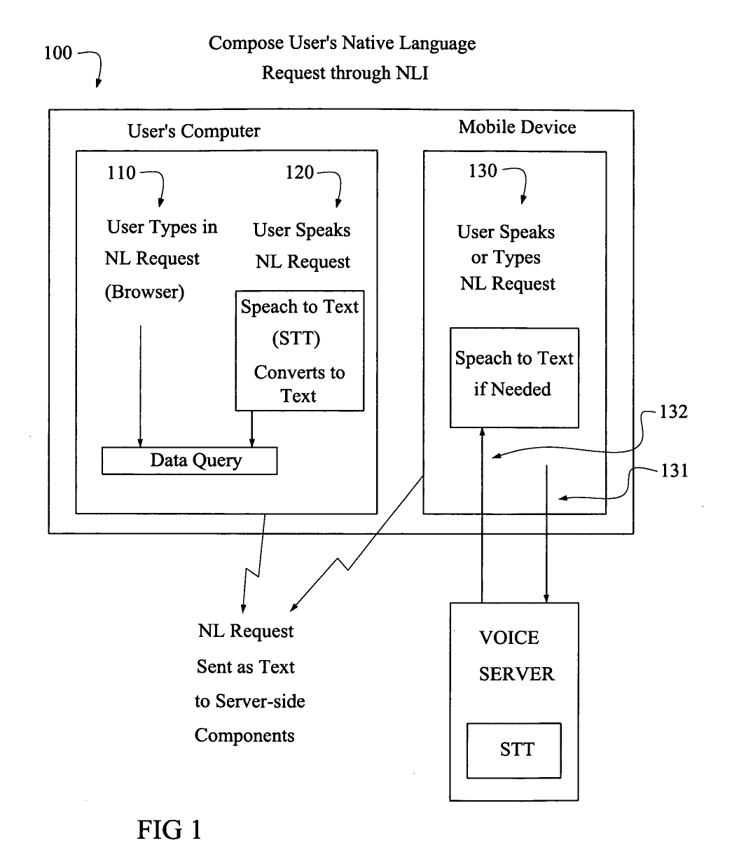

FIG. 1 shows the Natural Language Interface methods by which an end user composes a Natural Language (NL) request. The end user interacts with the system in one of three ways: a) typing the request as a short sentence or question into a text box on a browser screen, b) speaking the request and relying on a Speech-to-Text (STT) software program, running concurrently on the user's computer, to convert it to text, or c) speaking the request into the user's mobile device, which then interacts with a Voice Server that utilizes an STT program to convert the vocal request to text and return it to the mobile device as a short text message.

One embodiment of the invention is a distributed processing system architecture 100. An end user interacts with the system by typing an information request as a short sentence or question into a text box on a browser screen 110.

In a second embodiment of a distributed processing system architecture 120, an end user's computer is equipped with a Speech-to-Text (STT) software program. In practice, the user speaks the NL request and the STT immediately converts it to text and into a text box in the end user's browser, just as if the user typed it. In a third embodiment 130, a user's mobile device 132 sends a spoken NL request to a Voice Server 131, which performs the STT function and returns a short text message to the mobile device 132. Next, the information request is sent over the internet to the server-based components of the distributed processing system.

### Pattern-Matching NL Request Phrases to Semantic Phrases in an Ontology Taxonomy

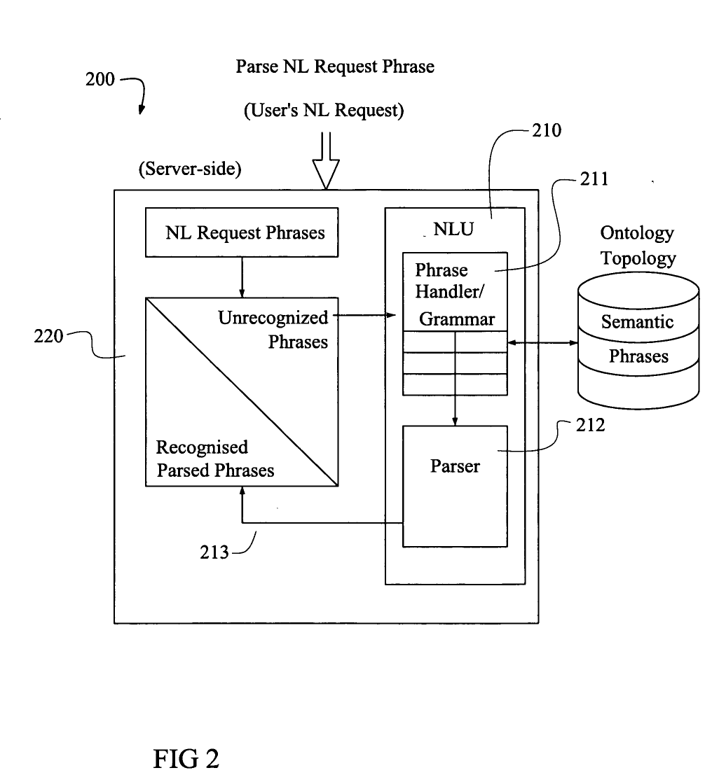

FIG. 2 shows the first server-side component module receiving the end user's NL request. This module parses NL request phrases against semantic phrases in an ontology taxonomy. A novel Natural Language Understanding (NLU) method contains phrase handlers that parse phrases within the NL request against their valid set of phrase grammars.

In one embodiment, the end user's NL request is received by the first server-side component 200 of the invention. This is sometimes called a “semantic phrase resolution” phase, and it matches the NL request phrases by name against semantic phrases or their synonyms in an ontology taxonomy (such name matching is sometimes called ‘pattern-matching’). This semantic phrase resolution phase is preferably “multi-lingual”, meaning that it can match and resolve phrases of different human languages (such as French or Spanish) within the same NL request sentence.

The invention may include a Natural Language Understanding (NLU) module 210 that parses the NL request as “chunks” of phrases, utilizing a set of phrase handler modules 211 that are specialized to understand certain key phrase constructs (such as temporal phrases, geospatial phrases, noun phrases, “action phrases” consisting of subject—verb—object, aggregation phrases, prepositional phrases, conjunctions).

Each phrase handler submits the collection of phrases it “understands” to a parser, along with a valid set of phrase grammars 212. As each set of phrases passes the phrase handler parsing 213, that collection of phrases is subtracted from a list of “unrecognized phrases” 220 and the next phrase handler attempts to understand all or part of the remaining phrases in the NL request sentence.

### Clarification Dialog

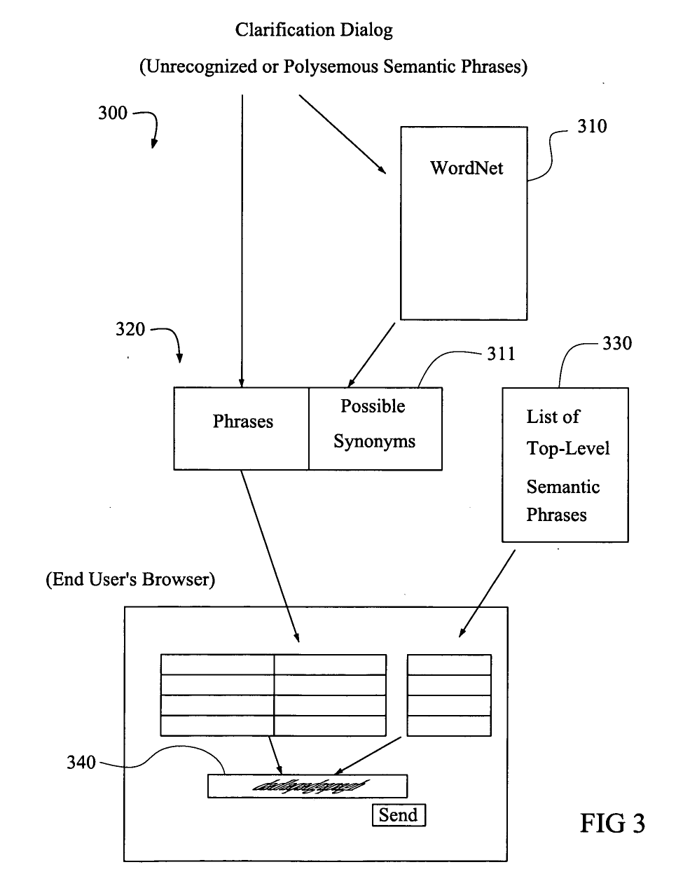

FIG. 3 shows a Clarification Dialog between the system and the user on his or her browser. This dialog is engaged if any NL request phrase is not understood, or if multiple matching semantic phrases are found. The Clarification Dialog prompts the user to clarify the request or type it over, after which process the new or clarified request is sent back to this module.

After all phrase handlers have attempted to parse unrecognized phrases, if any NL request phrase is not recognized as a semantic phrase in the ontology taxonomy, at any level, or if a NL request phrase is matched against more than one semantic phrase, a Clarification Dialog 300 is engaged with the user on his or her browser to either clarify the request or type it over.

The first process 310 in the Clarification Dialog process is to submit any unrecognized NL request phrases or those matching names of multiple (polysemous) semantic phrases in the Ontology taxonomy to WordNet, an open source “terminological ontology” containing thousands of words and phrases, organized by “word sense”.

If any match is found for the unrecognized NL request phrase or any duplicate phrase matching was ostensibly resolved through WordNet, these matching phrases and their WordNet “sense” are sent along with the phrases to be clarified to the Clarification Dialog 311. A list of one or more unrecognized or poloysemous phrases is presented to the user 320, along with any WordNet-supplied synonyms for the phrases. Also a list of semantic phrases from the top-level ontology for the current NL requests is presented, for the user to browse and select from to clarify an unrecognized phrase 330.

The requesting user takes one of four actions in interacting with the Clarification Dialog: a) if there is an unrecognized phrase, the user can re-word it (it may have been just a typo), b) if there are multiple matching semantic phrases, the user can select the preferred meaning from a list, c) the user can retype the entire request sentence, or d) the user can abandon the request. Once all NL request phrases sent to the Clarification Dialog are resolved, the revised (or re-entered) NL request 340 is sent back to the first server-side component 200 to be re-evaluated.

### Mapping Matched Semantic Phrases to Ontology Concept Objects

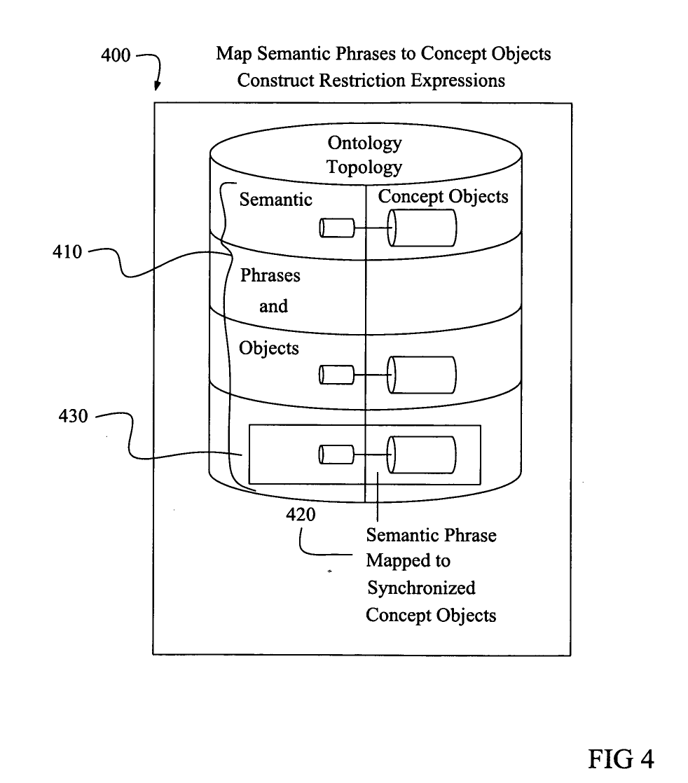

FIG. 4 shows a server-side process that maps the pattern-matched semantic phrases to synchronized ontology concept objects and constructs any restriction conditions implied in the NL request.

After all NL request phrases have been successfully understood, the next server-side process 400 maps the mapped semantic phrases found in the ontology taxonomy to synchronized concept objects at the same subject area/model view level in the taxonomy.

The functional separation between semantic phrase matching and concept object mapping within the same ontology taxonomy is a valuable aspect of one embodiment of the current invention, and is a practice called “separation of concerns”, that upon reading this disclosure is very much appreciated by practitioners in Computer Science.

In a semantic phrase transformation process 410 (via a semantic phrase transformation component), three types of semantic phrases are transformed to concept objects: (1) noun phrases that map to concept entities or entity attributes, (2) values that form restriction expressions in the form “entity.attribute<relational operator>value”, and (3) phrases that can be interpreted as a structural command or clause in a database language such as SQL (e.g., “count”, “sum”, “group by”, “order by”, “having”). Non-noun semantic phrases such as verbs are not transformed. Synonyms are replaced with their anchor entity, attribute or value (after translation if in a foreign language).

A replacement process 411 replaces all synonyms with their anchor entity, attribute or value. Similarly, conversion process 412 converts Natural Language “restriction” phrases into relational operators (e.g., “after”, “past” become “>”, “on or before” becomes “<=”), while construction process 413 constructs the attribute <relational operator> value expressions. Additionally, a directive process 414 converts structural directives into the matching query constructs (e.g., “Total” becomes “Sum”, “How many” becomes “Count”, “By” becomes “Group By” if the NL command is “Count” or another aggregation phrase). The resultant semantic phrases are then mapped to concept objects 420, some of which form restrictions such as conditional expressions with relational operators and literal values 430.

### Reifying Ontology Taxonomy Concept Objects to Top-Level Ontology Concept Objects

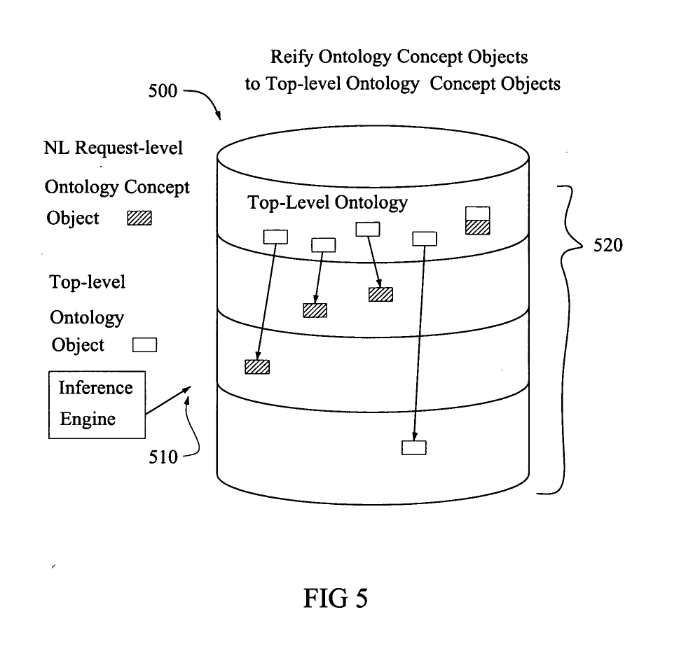

FIG. 5 shows the server-side process that utilizes inferencing to reify the matched ontology concept objects up to the top-level concept objects in the taxonomy.

Mapping concept objects directly to database metadata objects (i.e., objects defining the tables, columns, primary keys and foreign keys of target databases) is a method of creating database queries from NL requests. The current invention, in contrast, utilizes a novel method for this transformation that is not obvious to a practitioner of skill in the art—a method called reification 500. Through this method, concept objects found anywhere throughout an ontology hierarchy (taxonomy) are related by inferencing 510 to concept objects at a top level of subject area/model view, a “most specific” ontology level at which database metadata objects of an actual database exist. Effectively, top-level concept objects become “proxies” for their related source concept objects 520. Recall that the top-level concept objects have previously been mapped to these database metadata objects in the afore-mentioned semantification process.

### Mapping Top-Level Ontology Concept Objects to Database Metadata Objects for Target DataBases

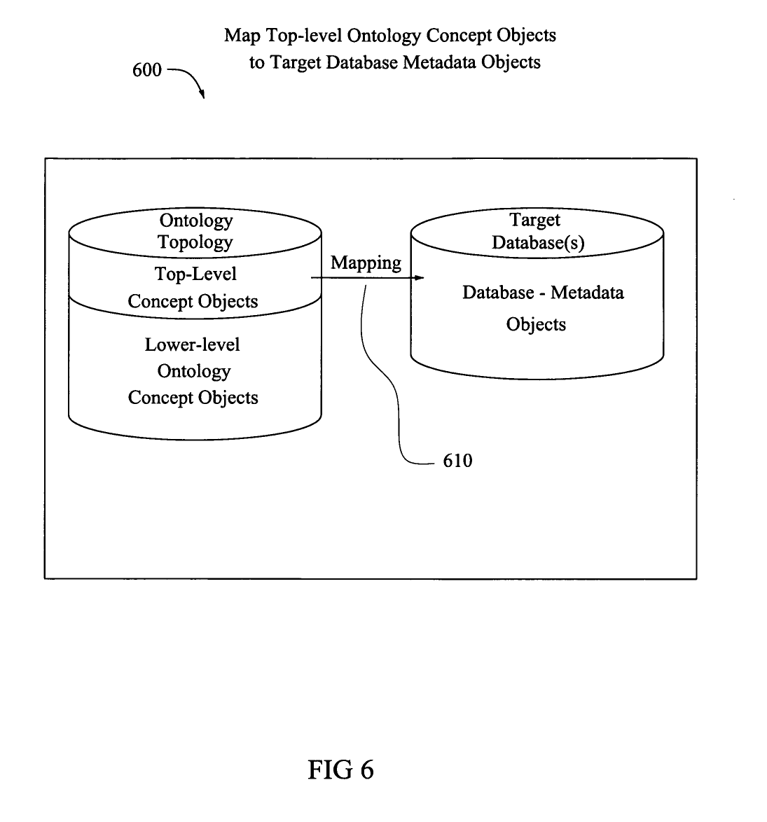

FIG. 6 shows a server-side process and architecture that maps the top-level ontology's concept objects to target database metadata objects. Accordingly, next, in a transformation process 600 performs the final transformation of reified concept objects into memory-based objects representing the database metadata objects of the user's targeted database(s). Only top-level concept objects need be mapped to database metadata objects 610.

### Database Query Generation

With an exception, the generation of executable database queries from the memory-based database metadata objects is rather straightforward, a process that upon reading this disclosure is obvious to a practitioner of skill in the art. The single exception that is not straightforward is the determination of the optimal set of join-clause expressions needed for automated database query generation. This invention's method of automated join-clause generation is thus discussed below.

### Navigation Path Algorithms to Determine Optimal Join-Clause

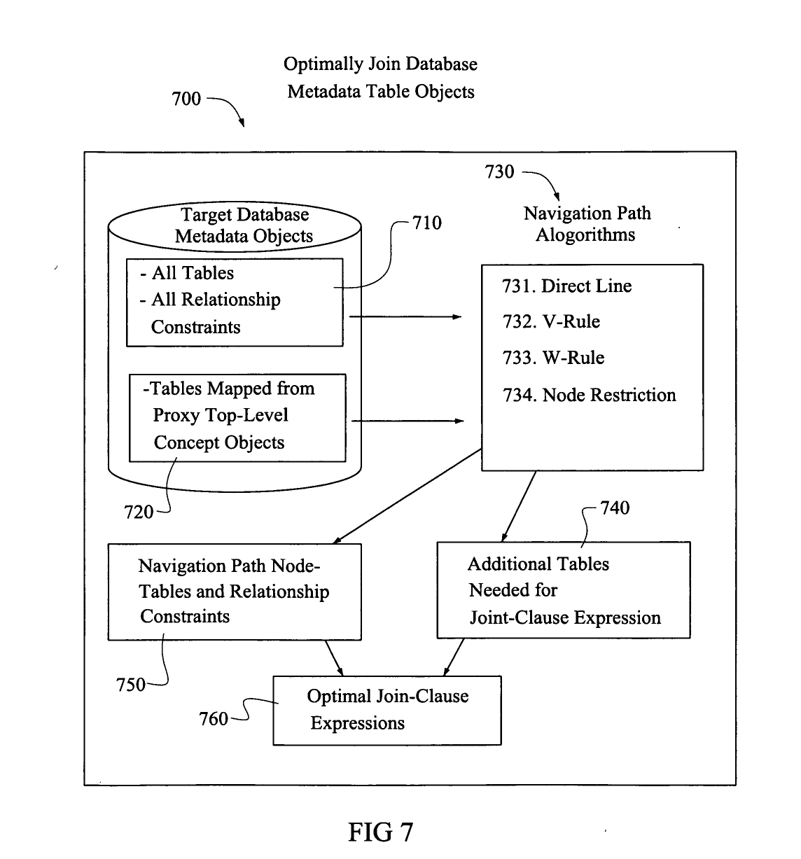

FIG. 7 shows a join clause process and architecture by which navigation path algorithms optimally join metadata objects to construct the JOIN clause of the database query statement. This process also adds to the “FROM” clause any “intermediate” table names not directly named in the NL request but needed to complete the database query properly.

Relational database consists of tables, each table having one or more columns of data (values), and each table being possibly related to other tables through a set of “relational integrity constraints”. Relational integrity constraints consist of relationships of tables, defined by the Primary Key column(s) of one table matched to the Foreign Key column(s) of a related table. If the database model is visualized as a graph, tables are boxes or circles (“nodes”) and relationships are lines connecting the nodes.

The “path” that connects all nodes in the graph that represent tables mentioned or inferred in a given query is called the “navigation path”. Join-clause expressions in a database query are constructed from the navigation path. Join-clause expressions are difficult to automatically determine, which is why Guided NLI approaches are used--they rely on the user's guidance to construct the join clause of a database query. But in “full sentence” NLIs such as the invention, the join-clause expressions must be created through navigation path automation algorithms.

In join clause process and architecture 700, all of the database metadata representing tables and relationship constraints for the target database(s) 710, along with the tables mapped from the top-level ontology concept objects 720, are submitted to the aforementioned navigation path algorithms. These navigation path algorithms 730 are invoked to determine the optimal join-clause expressions needed to construct an SQL statement for the current NL request. Navigation path algorithms 730 include a “direct-line” 731, a “v-rule” 732, a “w-rule” 733 and a “node restriction” 734. Any additional tables 740 needed, plus the navigation path tables and relational constraints 750, are then used to determine the optimal join-clause expressions 760.

If there is a need to include, say, four tables out of a total of 100 tables in a database, and these four tables are located at random nodes within a graph of the related tables, the optimum creation of the navigation path to interconnect these four tables is a difficult task, approaching the level of difficulty of the famous “traveling salesman” problem cited in computer science literature and known to those of ordinary skill in the art. The invention's navigation path algorithm successfully creates the join-clause expressions to complete the automation of generating SQL statements, a necessary part of a full-sentence NLI system.

Example of an NL request, and the SQL statement generated from it:

```
  “show western region seafood orders shipped via Federal Shipping
  in 2005”
  SELECT distinct i.regionDescription, e.categoryName,
  d.companyName, a.*
  FROM orders a, employees b, products c, shippers d, categories e,
orderDetails f,
    employeeTerritories g, territories h, region i
  WHERE
  -- Join-clause expressions:
    a.employeeid = b.employeeid and a.orderID = f.orderID
    and f.productID = c.productID and c.categoryID = e.categoryID
    and a.shipVia = d.shipperID and b.employeeID = g.employeeID
    and g.territoryID = h.territoryID and h.regionID = i.regionID
  -- Restriction conditional expressions:
    and i.regionDescription = ‘Western’ and e.categoryName = ‘seafood’
    and d.companyName = ‘Federal Shipping’ and
    year(a.shippedDate) = 2005
```

Note that of the nine tables in the FROM clause, only four tables are mentioned or inferred in the NLI request (region, categories through ‘Seafood’, shippers through ‘Federal Shipper’, and orders). Also there are eight join-clause expressions in this SQL statement. The invention's navigation path algorithm automatically added the other five tables necessary to connect all mapped database tables that were mentioned or indirectly identified in the user request, and automatically constructed the proper join-clause expressions to complete the SQL statement. Accordingly, the invention's navigation path algorithms choose the optimal navigation path between table relationships in a single database or within two or more federated target databases.

### Semi-Automated Extensibility of Ontology Semantic Phrases and Concept Objects

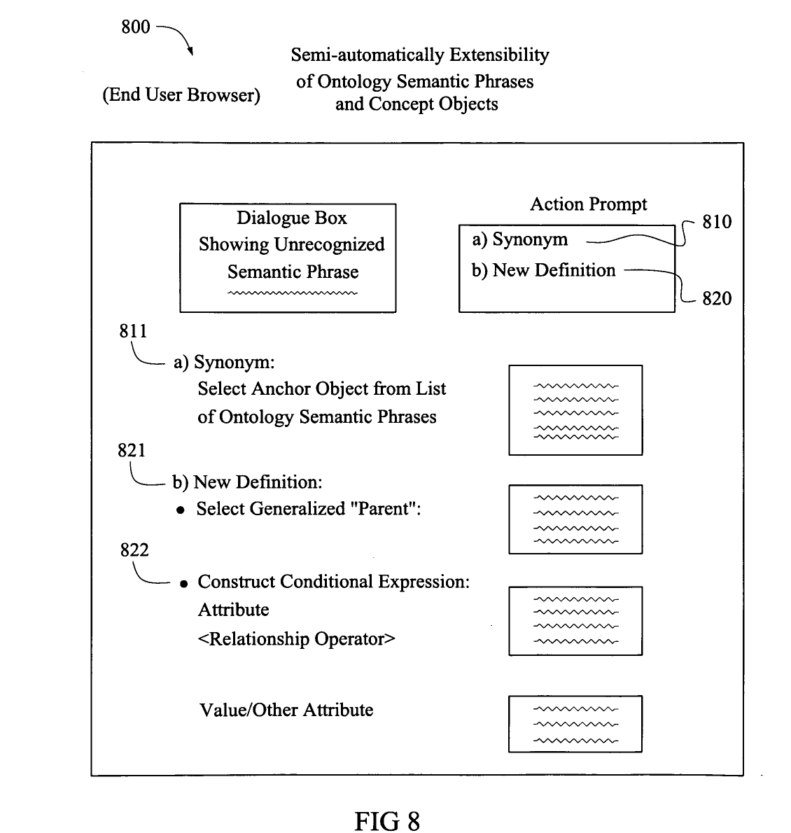

FIG. 8 shows an alternative embodiment of the invention that semi-automatically extends semantic phrases and any mirrored concept objects by prompting the user to supply a new synonym or to define a new phrase with conditional expressions that “specialize” the phrase, effectively providing a novel method of adding semantic phrases and concept objects “on-the-fly”, during the normal use of an implementation of the invention 800.

This alternative embodiment is an extension to the Clarification Dialog that prompts a user to substitute an unrecognized semantic phrase with a synonym of an existing semantic phrases in the ontology taxonomy 810. If the new semantic phrase is not a synonym, then the user must “define” a new phrase and its mirrored concept object 820.

Some unrecognized phrases are new synonyms of current semantic phrases already stored in the ontology. Accordingly, if the user states these new phrases as synonyms 811, then they are automatically add to the ontology's repository as synonyms (one type of semantic phrase), so that the next time the word or phrase is used in an NL request it will be recognized without need for prompted clarification (this invention contemplates foreign language synonyms).

If a new phrase added by the user is not a synonym of a known semantic phrase in the invention's ontology taxonomy, then it is defined as a “specialized” semantic phrase mirrored to a concept object. The user “specializes” the new phrase by invoking the “is a” relationship (hypernymy) to a known semantic phrase 821, and then provides the differentiating conditional expression through an “expression builder” GUI 822. This “specialization condition” differentiates the new semantic phrase/concept object from its generalized parent object.

One type of semantic phrase is a “noun phrase”, where the noun may be an entity or an attribute of a known entity. An example is the noun phrase “sales rep”. Say the ontology includes the entity concept object “employee” and another entity concept object “title”, and these concept objects ultimately map to tables called “Employee” and “EmployeeTitle” respectively. Say that the “EmployeeTitle” table has a column “titleName” that includes a data value “Sales Representative”. So the user would define the new phrase “sales rep” as being an employee (sales rep “is a” employee), with a condition expression “title=‘sales representative’.”

In this invention, the user does not have to manually relate the two entities, “employee” and “title”. The invention's navigation path algorithm will find the navigation path between the mapped tables “Employee” and “EmployeeTitle”, even if they are not directly related.

Another type of semantic phrase is an “action phrase”, consisting of a subject phrase, an “action verb phrase”, and an object phrase. Action phrases are stored as or are treated as “triples” because they comprise three component phrases of action. Since there are three component phrases of an action phrase triple, if any two of the three phrase components are recognized, the unrecognized phrase can be either added as a synonym to the third phrase to a known action phrase, or can form a new action phrase combined with the two recognized phrases.

As an example, say there is an action phrase “sales rep books sales order”. The subject phrase is “sales rep”, the action verb phrase is “books”, and the object phrase is “sales order”.

If an NL request is “which sales reps placed the most sales orders?”, the semantic phrase “sales rep” is recognized (morphology normalizes plurality/singularity), and the object phrase “sales order” is recognized. So two phrases of the triple in “sales rep books sales order” are recognized, thus the invention would prompt the user to state whether the unrecognized phrase “placed” or “places” is a synonym of “books”. Say that “places” and “books” seem synonymous to the user, so the new synonym “places” is added as a synonym for the verb phrase “books” (it is only a synonym with respect to the action phrase “sales rep books sales order”).

But another NL request might come along “which sales reps canceled sales orders last month?” The user would say that “cancels” is not synonymous with “books”, in which case a new action phrase must be defined if it is to be added to the ontology's semantic phrase lexicon. The invention asks the user to define the new verb phrase, “cancels”, because if a new verb phrase is not synonymous with a known verb phrase for a known action phrase relating the two known noun phrases, it must be a specialized relationship, requiring an “is a” relationship and “specialization condition”. Say that there is an attribute “canceled Date” in the Sales Order concept object that maps to a column “dateCanceled” in a table called “Orders”. So the user can define the new action phrase “sales rep cancels sales order” as the known “sales rep” and “sales order” concept objects, the verb phrase “cancels”, and the conditional expression “sales order.canceled Date is empty” (“not null”). Accordingly, this embodiment allows the semantic phrases and concept objects of the invention's ontology taxonomy to be extended through normal use of the invention.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A method, comprising sequentially:
receiving a natural language request, the natural language request being composed of phrases stated in, or convertible to, the common vernacular used in every-day natural language;
parsing phrases in the natural language request against semantic phrases stored in a hierarchical set of ontologies;
mapping the semantic phrases to conceptual objects that have been synchronized with semantic phrases in the same taxonomy;
transforming the mapped conceptual objects, through a rules-based inferencing process, to database objects stored in a repository of database metadata for one or more target databases previously prepared through mappings to ontology objects;
from the mapped database objects, generating an executable database query statement in a suitable database query language; and
sending the database query results to the requesting user.

2. The method of claim 1 further comprising discovering a new phrase entered by the user in a natural language, and upon clarification by the user, adding this new phrase to an existing semantic phrase repository, and adding the phrase in a base language in a synchronized concept model repository, the two synchronized sets of objects defining a ‘semantified’ ontology taxonomy.

3. The method of claim 1 further comprising generating a join clause of an executable database query statement by automating a navigation algorithm that connects all mapped database table objects that were identified indirectly in a single user request.

4. The method of claim three wherein the connections form an optimum path between table relationships in single or federated target databases.
